(19) United States
(12) Patent Application Publication
(10) Pub. No.: US 2026/0369566 A1
(43) Pub. Date: Nov. 19, 2026

(54) NCM ELECTRODE PARTICLE COATED WITH INTERPHASE LAYER AND NITROGEN-CONTAINED CARBON LAYER

(71) Applicant: ZHI FENG LUO, Shenzhen (CN)

(72) Inventor: ZHI FENG LUO, Shenzhen (CN)

(73) Assignee: Shenzhen TXD Technology Co., Ltd., Shenzhen, CN (CN)

(21) Appl. No.: 19/207,399

(22) Filed: May 14, 2025

(51) Int. Cl. H01M 4/36; H01M 4/02; H01M 4/04; H01M 4/525; H01M 4/583; H01M 10/0562

(52) U.S. Cl. CPC H01M 4/366; H01M 4/0407; H01M 4/525; H01M 4/583; H01M 10/0562; H01M 2004/021; H01M 2004/028; H01M 2300/0077

(57) ABSTRACT

An NCM electrode particle coated with an interphase layer and a nitrogen-contained carbon layer includes an NCM (lithium nickel manganese cobalt oxide) particle and the interphase layer coated on an outer surface of the NCM particle. The NCM particle coated with the interphase layer forms a primary particle. The interphase layer includes a glass phase layer and plural ceramic particles dispersed within the glass phase layer. The nitrogen-contained carbon layer is coated on an outer side of the primary particle. The nitrogen-contained carbon layer serves to increase the electrical conductivity of the NCM electrode particle.

### FIELD OF THE INVENTION

The present invention is related to electrolyte particles, and in particular to an NCM electrode particle coated with an interphase layer and a nitrogen-contained carbon layer.

### BACKGROUND OF THE INVENTION

A typical battery is mainly formed by the positive and negative electrodes placed in the electrolyte. The positive electrode is made by mixing and dispersing a large number of positive conductive units (positive electrode material, such as lithium cobalt oxide) in a positive slurry. The positive conductive units are connected to each other through the conductive slurry. Therefore, the conductive slurry must have enough conductivity in order to enable free electrons to migrate in different positive conductive units and do not have to consume too much energy due to the internal resistance, which achieves the purpose of effective conductivity. As a result, it is necessary to use a specific conductive material to make the slurry to adjust the conductivity.

To increase the conductivity, the positive slurry is filled with plural positive electrode particles which may be formed by NCM (lithium nickel manganese cobalt oxide) or LMFP (lithium manganese iron phosphate) mixtures. However, the interface of traditional positive electrode particles is easy to perform a side reaction and reduce the life of positive electrode, and also easy to degrade in the sintering during the manufacturing, resulting in a lower electrical conductivity and a poor battery performance.

### SUMMARY OF THE INVENTION

Accordingly, for improving above mentioned defects in the prior art, the object of the present invention is to provide an NCM electrode particle coated with an interphase layer and a nitrogen-contained carbon layer, wherein the interphase layer is coated on the outer surface of the NCM particle to reduce the risk of degradation of the NCM particle due to the inert gases used in the manufacturing of NCM electrode particle. The interphase layer also can increase the lithium-ion conductivity. Furthermore, the nitrogen-contained carbon layer is coated on the outer side of the interphase layer to increase the electrical conductivity of the NCM electrode particle.

To achieve above object, the present invention provides an NCM electrode particle coated with an interphase layer and a nitrogen-contained carbon layer; the NCM electrode particle being used in an electrode of a solid-state battery or semi-solid battery; the NCM electrode particle comprising: an NCM (lithium nickel manganese cobalt oxide) particle having a single crystal structure; the interphase layer being coated on an outer surface of the NCM particle; the NCM particle coated with the interphase layer forming a primary particle; the interphase layer including a glass phase layer and a plurality of ceramic particles dispersed within the glass phase layer; and the interphase layer serving to protect the NCM particle and increase a lithium ion conducting effect; a nitrogen-contained carbon layer coated on an outer side of the primary particle; the NCM electrode particle being formed by the NCM particle, the interphase layer and the nitrogen-contained carbon layer; and the nitrogen-contained carbon layer serving to increase an electrical conductivity of the NCM electrode particle; and wherein nitrogen-doped carbon molecules in the nitrogen-containing carbon layer serves to increase an electronical conductivity and a lithium-ion conductivity of the NCM particles, and to change an electrical potential of the NCM particles; the nitrogen-contained carbon layer is formed by a calcination of a nitrogen-contained polymer material in an inert atmosphere, which is coated on the outer surface of the primary particle; and the carbon and nitrogen in the nitrogen-containing carbon layer form the conjugated C=N bonds to change an energy band and to reduce a required energy for exciting electrons to a conduction band, which increases the electrical conductivity.

### BRIEF DESCRIPTION OF THE DRAWINGS

FIG. 1 is a cross-section view showing the structure of the NCM electrode particle of the present invention.

FIG. 2 is an enlarged schematic view showing the structure of the NCM electrode particle of the present invention.

FIG. 3 is a schematic view showing the structure of the nitrogen-contained carbon layer of the present invention.

FIG. 4 is a schematic view showing an application of the present invention.

FIG. 5 is a schematic view showing the structure of the second order NCM composite particle of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

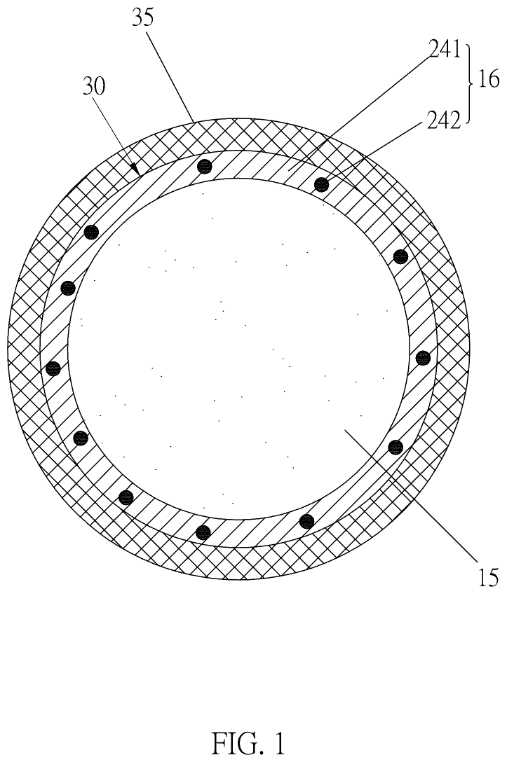

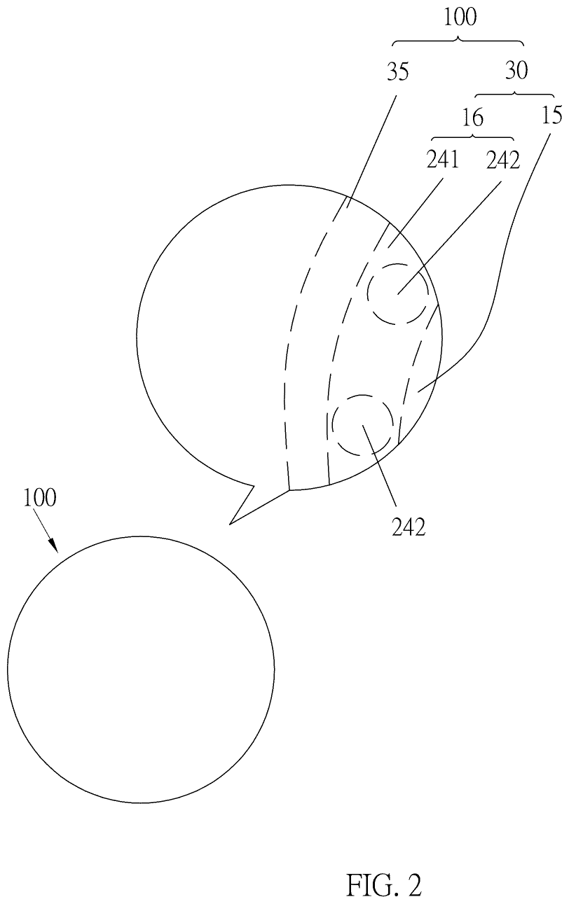

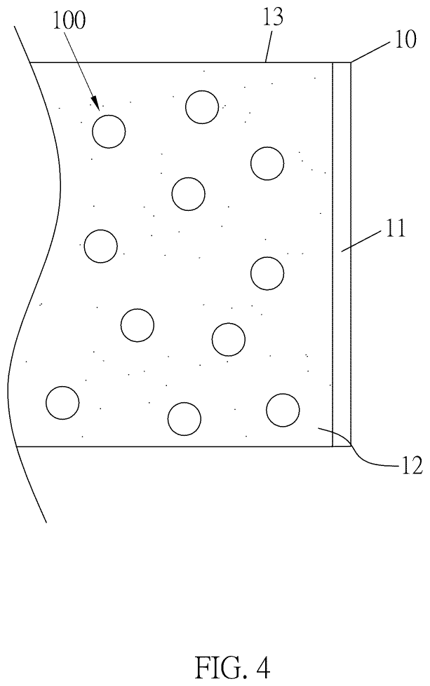

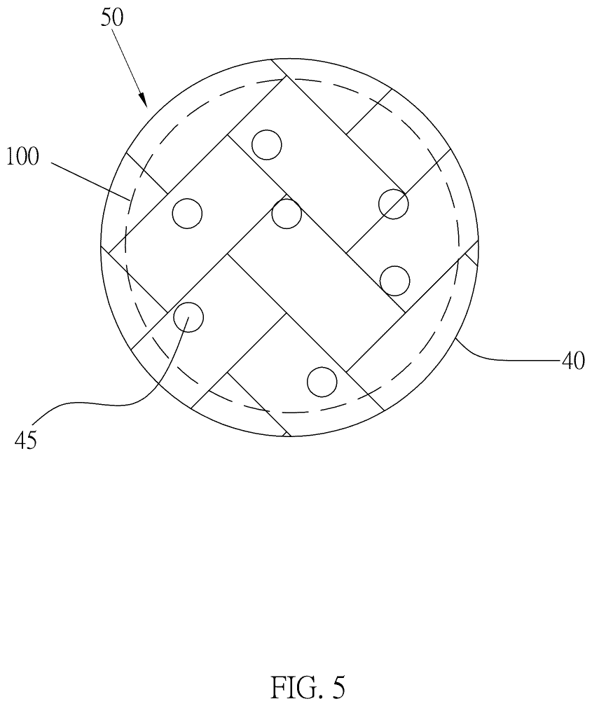

With reference to FIGS. 1 to 5, the present invention provides an NCM electrode particle 100 coated with an interphase layer and a nitrogen-contained carbon layer, which is used for an electrode 10 of a solid-state battery or semi-solid battery. In application, a plurality of NCM electrode particles 100 can be arranged within the electrode 10. Preferably, the electrode 10 is a positive (+) electrode. The NCM electrode particle 100 has a particle size less than 10 μm. Referring to FIG. 4, the electrode 10 includes a positive substrate 11 and a positive slurry layer 13 coated on the positive substrate 11. The positive slurry layer 13 includes the NCM electrode particles 100 and a positive electrode slurry 12 which is used as a binder. A weight percentage of the NCM electrode particles 100 in the positive slurry layer 13 is 80 wt %~98 wt %.

Referring to FIG. 1, the NCM electrode particle 100 includes the following elements.

An NCM (lithium nickel manganese cobalt oxide) particle 15 has a single crystal structure. NCM is a ternary oxide. A D50 (mass-median-diameter, MMD) value of the NCM particle 15 is 3~5 μm. A D90 of the NCM particle 15 is not larger than 10 μm.

An interphase layer 16 is coated on an outer surface of the NCM particle 15. The NCM particle 15 coated with the interphase layer 16 forms a primary particle 30.

The interphase layer 16 includes a glass phase layer 241 and a plurality of ceramic particles 242 dispersed within the glass phase layer 241. The interphase layer 16 serves to protect the NCM particle 15 and increase the lithium ion conducting effect. A particle size of each of the ceramic particles 242 is less than 100 nm. A radial thickness of the glass phase layer 241 is 50 nm to 1 μm. A radial thickness of the interphase layer 16 is 50 nm to 1 μm. In the interphase layer 16, a ratio of a total weight of the ceramic particles 242 and a weight of the glass phase layer 241 is 10~1:~10.

The glass phase layer 241 is formed by an amorphous oxide which is formed by heat treating and has a lithium ion conductivity higher than 10⁻⁵ S/cm (Siemens per centimeter). The amorphous oxide can be a lithium-contained oxide or an amorphous oxide-based solid-state electrolyte. The lithium-contained oxide is formed by lithium (Li) and a chemical element in group IIIA (boron group), group IVA (carbon group) or group VA (nitrogen group) of a periodic table. The lithium-contained may be Li₂O—ROₓ, wherein x=1~3, and R is selected from boron (B), aluminum (Al), silicon (Si), germanium (Ge), phosphorus (P) and arsenic (As).

The amorphous oxide-based solid-state electrolyte is selected from at least one of an amorphous perovskite solid-state electrolyte (Li—La—Ti—O, lithium lanthanum titanium oxide, LLTO)), a garnet-based solid-state electrolyte (such as Li—La—Zr—O, lithium lanthanum zirconium oxide, LLZO), a lithium phosphorus oxynitride (LiPON), and lithium aluminum titanium phosphate (LATP).

The glass phase layer 241 has an unspecified element arrangement. The glass phase layer 241 is a continuous thin film layer coated on the outer surface of the NCM particle 15.

The ceramic particles 242 are formed by an oxide with a protective effect (such as Al₂O₃ or SiOₓ (0<x≤2)), or a ceramic oxide capable of increasing the lithium ion conductivity (such as a solid electrolyte material).

The solid electrolyte material is formed by a first oxide or phosphate capable of conducting lithium ions, or is formed by a second oxide with a garnet structure or a perovskite structure. A lithium ion conductivity of the first oxide or phosphate is higher than 10⁻⁵ cm²/s (diffusion coefficient). The first oxide or phosphate may be LATP (lithium aluminum titanium phosphate) with a NASICON (sodium (Na) super ionic conductor) structure, LAGP (lithium aluminium germanium phosphate), or lithiophosphate (Li₃PO₄). The second oxide with the garnet structure or the perovskite structure may be LLZO (Li₇La₃Zr₂O₁₂, lithium lanthanum zirconium oxide) or LLTO (lithium lanthanum titanium oxide). The ceramic particles 242 can be formed by combination of above materials with any ratio.

The NCM electrode particle 100 is formed by an inert atmosphere sintering. Because NCM is easy to degrade and deteriorate in the inert atmosphere to cause the battery performance become unstable, the interphase layer 16 is used to protect the NCM particle 15. The interphase layer 16 is less sensitive to oxygen and is stable in the inert atmosphere, which can protect the NCM particle 15 from the affecting of the inert atmosphere.

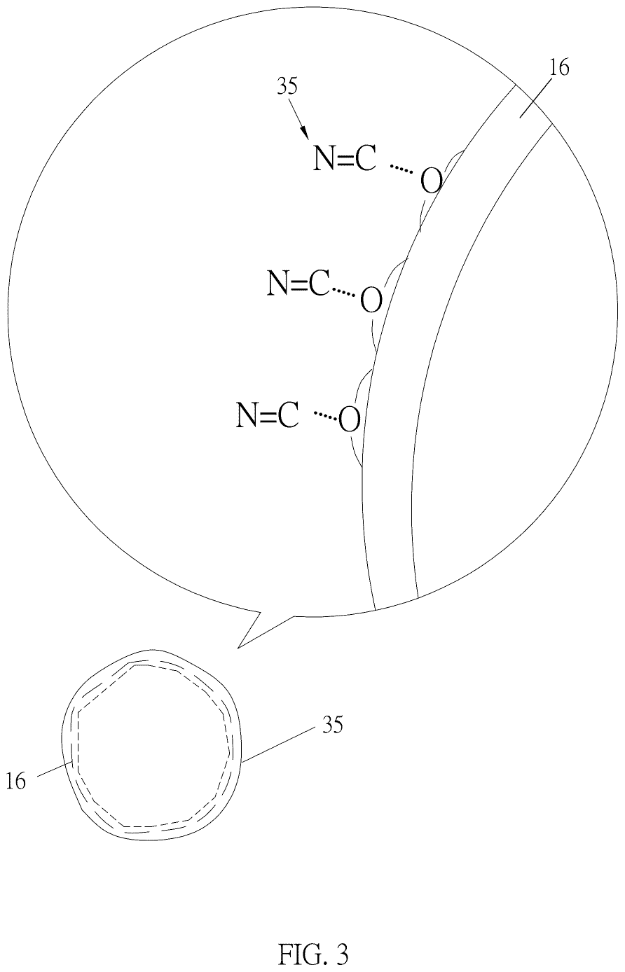

A nitrogen-contained carbon layer 35 is coated on an outer side of the primary particle 30. The NCM electrode particle 100 is formed by the NCM particle 15, the interphase layer 16 and the nitrogen-contained carbon layer 35, as shown in FIG. 1. A radial thickness of the nitrogen-contained carbon layer 35 is less than or equal to 0.2 μm. The nitrogen-contained carbon layer 35 serves to increase the electrical conductivity of the NCM electrode particle 100. Referring to FIG. 3, the nitrogen-contained carbon layer 35 is formed by a plurality of highly-ordered carbon structures containing C=N double bonds (carbon-nitrogen double bonds). The highly-ordered carbon structures are bonded to lone pairs (pairs of valence electrons) of oxygen ions on an outer surface of the interphase layer 16 by hydrogen bonds, which form the nitrogen-contained carbon layer 35 coated on the outer side of the primary particle 30.

The purpose of coating the nitrogen-contained carbon layer 35 on the outer surface of the primary particle 30 is that, nitrogen-doped carbon molecules in the nitrogen-containing carbon layer 35 serves to increase an electronical conductivity and a lithium-ion conductivity of the NCM particles 15, and to change an electrical potential of the NCM particles 15, and thus improves the performance of the entire battery. The nitrogen-contained carbon layer 35 is formed by a calcination of a nitrogen-contained polymer material in an inert atmosphere, which is coated on the outer surface of the primary particle 30. The nitrogen-contained polymer material may be polydopamine (PDA) or any material capable of producing conjugated C=N bonds (an unsaturated conjugated system containing carbon and nitrogen) by using a calcination. The carbon and nitrogen form the conjugated C=N bonds to change the energy band and to reduce the required energy for exciting electrons to the conduction band, which increases the electrical conductivity.

Referring to FIG. 6, an outer surface of the NCM electrode particle 100 is further coated with a plurality of carbon nanotubes 40 and a plurality of nanoscale amorphous carbons 45 to form a second order NCM composite particle 50. Each of the carbon nanotubes 40 has a length of 200~500 nm. Each of the nanoscale amorphous carbons 45 has a length of 10~40 nm. The nanoscale amorphous carbons 45 are amorphous carbons of a Super P auxiliary agent.

A ratio of a total weight of the carbon nanotubes 40 and the nanoscale amorphous carbons 45 and a weight of the NCM particle 15 is 0.2~2: 99.8~98.

The carbon nanotubes 40 serve to increase the conductivity of the electrons. The carbon nanotubes 40 are randomly distributed on outer surfaces of the NCM electrode particle 100. The carbon nanotubes 40 have an extremely high electrical conductivity, so that the electrons can pass through the carbon nanotubes 40 and conduct between different NCM electrode particles 100, which increase the electrical conductivity of the electrode 10.

The carbon nanotubes 40 and the nanoscale amorphous carbons 45 are used as an auxiliary agent. The nanoscale amorphous carbons 45 are in a form of particles, and the carbon nanotubes 40 are in a form of long strips, and the nanoscale amorphous carbons 45 are filled in the gaps formed between the carbon nanotubes 40 to transmit the electric charge between the carbon nanotubes 40 through the spanning of the nanoscale amorphous carbons 45, which further increases the transmitting efficiency of the electric current.

The advantages of the present invention are that, the interphase layer is coated on the outer surface of the NCM particle to reduce the risk of degradation of the NCM particle due to the inert gases used in the manufacturing of NCM electrode particle. The interphase layer also can increase the lithium-ion conductivity. Furthermore, the nitrogen-contained carbon layer is coated on the outer side of the interphase layer to increase the electrical conductivity of the NCM electrode particle.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An NCM electrode particle coated with an interphase layer and a nitrogen-contained carbon layer; the NCM electrode particle being used in an electrode of a solid-state battery or semi-solid battery; the NCM electrode particle comprising:
an NCM (lithium nickel manganese cobalt oxide) particle having a single crystal structure;
the interphase layer being coated on an outer surface of the NCM particle; the NCM particle coated with the interphase layer forming a primary particle; the interphase layer including a glass phase layer and a plurality of ceramic particles dispersed within the glass phase layer; and the interphase layer serving to protect the NCM particle and increase a lithium ion conducting effect;
the nitrogen-contained carbon layer coated on an outer side of the primary particle; the NCM electrode particle being formed by the NCM particle, the interphase layer and the nitrogen-contained carbon layer; and the nitrogen-contained carbon layer serving to increase an electrical conductivity of the NCM electrode particle; and
wherein nitrogen-doped carbon molecules in the nitrogen-containing carbon layer serves to increase an electronical conductivity and a lithium-ion conductivity of the NCM particles, and to change an electrical potential of the NCM particles; the nitrogen-contained carbon layer is formed by a calcination of a nitrogen-contained polymer material in an inert atmosphere, which is coated on the outer surface of the primary particle; and the carbon and nitrogen in the nitrogen-containing carbon layer form the conjugated C=N bonds to change an energy band and to reduce a required energy for exciting electrons to a conduction band, which increases the electrical conductivity.

2. The NCM electrode particle coated with the interphase layer and the nitrogen-contained carbon layer as claimed in claim 1, wherein the nitrogen-contained carbon layer is formed by a plurality of highly-ordered carbon structures containing C=N double bonds; and the highly-ordered carbon structures are bonded to lone pairs of oxygen ions on an outer surface of the interphase layer by hydrogen bonds, which form the nitrogen-contained carbon layer.

3. The NCM electrode particle coated with the interphase layer and the nitrogen-contained carbon layer as claimed in claim 1, wherein a D50 (mass-median-diameter, MMD) value of the NCM particle is 3~5 μm; a particle size of each of the ceramic particles is less than 100 nm; a radial thickness of the glass phase layer is 50 nm to 1 μm; a radial thickness of the interphase layer is 50 nm to 1 μm; and in the interphase layer, a ratio of a total weight of the ceramic particles and a weight of the glass phase layer is 10~1:1~10.

4. The NCM electrode particle coated with the interphase layer and the nitrogen-contained carbon layer as claimed in claim 1, wherein the glass phase layer is formed by an amorphous oxide which is formed by heat treating and has a lithium ion conductivity higher than 10⁻⁵ S/cm (Siemens per centimeter); the glass phase layer has an unspecified element arrangement; and the glass phase layer is a continuous thin film layer coated on the outer surface of the NCM particle.

5. The NCM electrode particle coated with the interphase layer and the nitrogen-contained carbon layer as claimed in claim 4, wherein the amorphous oxide is formed by lithium (Li) and a chemical element in group IIIA (boron group), group IVA (carbon group) or group VA (nitrogen group) of a periodic table.

6. The NCM electrode particle coated with the interphase layer and the nitrogen-contained carbon layer as claimed in claim 5, wherein the amorphous oxide is Li₂O—ROₓ, wherein x=1~3, and R is selected from boron (B), aluminum (Al), silicon (Si), germanium (Ge), phosphorus (P) and arsenic (As).

7. The NCM electrode particle coated with the interphase layer and the nitrogen-contained carbon layer as claimed in claim 1, wherein the ceramic particles are formed by an oxide with a protective effect, or a ceramic oxide capable of increasing the lithium ion conductivity.

8. The NCM electrode particle coated with the interphase layer and the nitrogen-contained carbon layer as claimed in claim 7, wherein the ceramic particles are formed by Al₂O₃ or SiOₓ, wherein 0<x≤2.

9. The NCM electrode particle coated with the interphase layer and the nitrogen-contained carbon layer as claimed in claim 7, wherein the ceramic particles are formed by a solid electrolyte material.

10. The NCM electrode particle coated with the interphase layer and the nitrogen-contained carbon layer as claimed in claim 9, wherein the solid electrolyte material is formed by a first oxide or phosphate capable of conducting lithium ions, or is formed by a second oxide with a garnet structure or a perovskite structure; and a lithium ion conductivity of the first oxide or phosphate is higher than 10⁻⁵ cm²/s (diffusion coefficient).

11. The NCM electrode particle coated with the interphase layer and the nitrogen-contained carbon layer as claimed in claim 10, wherein the first oxide or phosphate is selected from LATP (lithium aluminum titanium phosphate) with a NASICON (sodium (Na) super ionic conductor) structure, LAGP (lithium aluminium germanium phosphate).

12. The NCM electrode particle coated with the interphase layer and the nitrogen-contained carbon layer as claimed in claim 10, wherein the second oxide with the garnet structure or the perovskite structure is selected from LLZO (Li₇La₃Zr₂O₁₂, lithium lanthanum zirconium oxide) or LLTO (lithium lanthanum titanium oxide).

13. The NCM electrode particle coated with the interphase layer and the nitrogen-contained carbon layer as claimed in claim 1, wherein a radial thickness of the nitrogen-contained carbon layer is less than or equal to 0.2 μm.

14. The NCM electrode particle coated with the interphase layer and the nitrogen-contained carbon layer as claimed in claim 1, wherein the nitrogen-contained polymer material is polydopamine (PDA) or a specific material capable of producing the conjugated C=N bonds by using a calcination.

15. The NCM electrode particle coated with the interphase layer and the nitrogen-contained carbon layer as claimed in claim 1, wherein an outer surface of the NCM electrode particle is further coated with a plurality of carbon nanotubes and a plurality of nanoscale amorphous carbons.

16. The NCM electrode particle coated with the interphase layer and the nitrogen-contained carbon layer as claimed in claim 15, wherein each of the carbon nanotubes has a length of 200~500 nm; and each of the nanoscale amorphous carbons has a length of 10~40 nm.

17. The NCM electrode particle coated with the interphase layer and the nitrogen-contained carbon layer as claimed in claim 15, wherein a ratio of a total weight of the carbon nanotubes and the nanoscale amorphous carbons and a weight of the NCM particle is 0.2~2:99.8~98.
